(19) United States
(12) Patent Application Publication
(10) Pub. No.: US 2005/0247160 A1
(43) Pub. Date: Nov. 10, 2005

(54) Vibration reducing link

(76) Inventors: The Hanh Ha, Blainville (CA); Christian Bissonnette, Saint-Elie-d'Orford (CA); Roch Gaudreau, St-Jerome (CA)

Correspondence Address: Robert Brouillette;BROUILLETTE & PARTNERS, 23rd Floor, 1100 Rene-Levesque Boulevard West, Montreal, QC, H3B 4N4, CA

(21) Appl. No.: 11/109,814

(22) Filed: Apr. 20, 2005

(30) Foreign Application Priority Data
May 7, 2004 (CA) 2,466,556

(51) Int. Cl. B62K 13/06

(52) U.S. Cl. 74/551.2; 280/276

(57) ABSTRACT

The present invention relates to a vibration dampening mechanism for use in recreational vehicle applications, preferably for connecting the steering stem to handle bars or other similar steering device. The vibration and noise dampening connection mechanism in accordance with the present invention includes a rubber element entrapped and bonded between two plates, linking the handlebar and the steering post of recreational vehicles. [NOTE: As used herein, the term “rubber” relates to any elastic and primarily non-metallic materials such as rubber, elastomers, or combinations thereof].

### BACKGROUND OF THE INVENTION

1. Field of the Invention

The present invention relates to a vibration dampening connection mechanism for use in connecting two component parts together. In particular, the present invention relates to a vibration dampening mechanism for use in recreational vehicle applications, preferably for connecting the steering stem to handle bars or other similar steering device.

The present invention, however, is not limited to use solely in recreational vehicle applications; rather, it is contemplated that the present invention may be used in any environment where it is desirable to control the transmission of vibration. In particular, the present invention is directed to a vibration dampening mechanism that ensures that the transfer of vibration between two components is minimized.

2. Description of the Related Art

Many recreational vehicles (e.g., an ATV, scooter, motorcycle, bicycle, snowmobile, personal watercraft, and other similar on-road or off-road vehicles) are built with handlebars as a means for steering and controlling the vehicle. The handlebar assembly is usually mounted to the front wheel through a front suspension assembly via a stem, column or post. The handlebar is often an elongated, tubular member that extends in a generally lateral direction and includes a handgrip portion at each end, for a rider of the vehicle to grasp. Such an arrangement also provides a means of support for a portion of the rider's body weight, especially when in a standing position. Also, some types of tools employ handlebars, such as jackhammers and the like. Controlling vehicles can be very challenging, particularly at high speeds or in rough riding conditions. In order to keep control of them, it is important to be able to maintain a consistent firm grip of the handlebars during the duration of their use.

While providing a straight maneuverability of the vehicle, it unfortunately results in the transmission of all the vibrations coming from the trail and engine right to the driver. With engines growing stronger and vehicle speeds increasing, so is the vibrations level at the handlebars. This leads to numerous physical problems accounted by drivers: numb hands, fatigue in arms and shoulders, perception loss, accuracy loss in handling, and so on. Comfort and performance are big concerns in the recreational vehicle industry. Reducing fatigue and discomfort caused by vibrations is highly desirable for drivers.

In the case of off-road motorcycles and ATV's, the vehicle is likely to traverse rough terrain, including jumps, on a regular basis. Unless adequately absorbed, forces imparted on the vehicle due to the rough nature of the terrain may be transmitted to the rider through the handlebar assembly. This may cause undesirable fatigue and result in the rider having reduced control of the vehicle. Such a situation is especially undesirable in motorcycle or ATV racing, in which maintaining a consistent pace throughout the event is necessary in order to be competitive.

In order to absorb at least a portion of the impact forces caused by traversing rough terrain, motorcycles and ATVs are commonly equipped with front and rear suspension assemblies operably positioned between the front and rear wheel, or wheels, and the main body of the vehicle. Such suspension assemblies, due to inherent design constraints, are only capable of absorbing impact forces within a finite range of magnitude and/or frequency. Accordingly, impact forces outside of this range may be transmitted to the rider of the vehicle, through the handlebar assembly, despite the proper functioning of the front and rear suspension assemblies. For example, an impact force having an amplitude large enough to fully compress either, or both, of the front and rear suspension assemblies may result in the remainder of the force being transmitted to the rider. In other situations, an impact force having a high frequency may not be adequately absorbed by the suspension assemblies, often due to internal friction inherent to common shock absorber designs, which may be caused by sealing arrangements and/or movement of hydraulic fluid.

ATV's have other challenges. They demand relatively high bending and torsional strengths of their frames. High strength requirements generally require a substantial measure of elasticity of the frame. However, the frame must also have a relative rigidity so as to not damage components of the ATV and maintaining good dynamic vehicle behavior. Therefore, the strength of the frame (which requires and introduces elasticity) must be balanced with the rigidity thereof. It is also known to rigidly mount the engine to the frame in order to provide additional strength/rigidity properties to the frame (i.e., with the rigidity of the engine itself). However, the engine then directly transmits engine vibration to the frame, which can dramatically affect rider comfort. Steps have been taken to reduce or damp vibration of the engine, so as to improve rider comfort. However, it has proved extremely costly to substantially decrease engine vibration so that the frame is not adversely affected by the vibration of the engine. It is known to resiliently mount the engine to the frame (such as with elastomeric bushings) so as to reduce transmission of engine vibration to the frame and to provide improved frames. See U.S. patent application Ser. No. 2002/0117843 (Rasidescu).

Some prior art handlebar assemblies have been designed to possess a certain amount of flexing movement. For example, the handlebar may be made from a material that possesses inherent flexibility to absorb at least a portion of the impact forces that would otherwise be transmitted to the rider. More recently, handlebars have been produced with a varying wall thickness to encourage flexing of the outer ends, or handgrip portions, of the handlebar. However, manipulation of the handlebar material in order to create a varying wall thickness causes the final product to be expensive. Furthermore, in order to maintain the necessary strength of the handlebar assembly, the flex of the handgrip portions is necessarily limited to a small amount of movement and, thus, a small amount of shock absorbing capability.

Finally, with this type of handlebar arrangement, the direction of movement during flexing of the handgrip portions is not controlled. That is, the handgrip portions are permitted to flex in all directions. Accordingly, the amount of advantageous, shock absorbing flex (i.e., generally downward flex of the handgrip portions) is limited by the amount of flex that is permissible in the other directions while still providing a handlebar assembly having a solid feel. As a result, the amount of shock absorbing flex permitted in these types of handlebar assemblies is compromised by the need for the handlebar assembly to provide a solid feel when a rider is pulling in an upward or backward direction on the handgrip portions, which is common during acceleration of the motorcycle or ATV.

Some have attempted to reduce vibrations by improving handlebar grips. U.S. Pat. No. 4,522,083 (Morgan) provides a handlebar grip for the drop portion of a racing bicycle handlebar. The grip includes a flexible elongated body for fitting over the handlebar. An enlarged palm and thumb cheek support member formed integrally with the elongated body having a wall that extends upward and outward over the elongated body. A vibration absorbing means is provided intermediate the wall and the elongated body for minimizing the transmission of vibration from the handlebar to the palm of the hand.

U.S. Pat. No. 4,380,093 (Morgan) shows a bicycle handlebar grip that is adapted to fit over the “cross-over” and “turn-of-bar” segments of a racing bicycle handlebar. The grip is shaped to allow a comfortable hand grip in any of several positions. The grip also includes provisions for reducing transmission of vibration front the handlebar to the rider's hand, thus avoiding physical ailments such as “biker's nerve palsy”.

Others have focused on providing anti-vibration billet handlebar clamps.

Still other have developed handlebars with a shock absorber (see U.S. patent application Ser. No. 2003/0121358 (Hissam).

It is also known to provide dampening connecting elements when connecting two components together when it is desirable to damp out unnecessary vibration. Often a seal is interposed between the two components in order to damp out vibration. In most instances, the connecting element itself comprises a bolt, a plain washer, and a molded body. The molded body is usually formed from an elastomeric material, such as rubber. Typically, the molded body incorporates a central opening and a shoulder-stepped flange that abuts against one outside surface of one component. The provision of the seal ensures that no vibration is directly transferred from one component to the other component. The molded body is provided to limit the indirect transfer of vibration from the first component to the second component through the bolt. A separate collar is often provided between the two components to form a stop for the bolt that is screwed into the second component. Such means are disclosed in U.S. Pat. No. 4,784,396, U.S. Pat. No. 5,255,647, DE 196 54 848 C2, EP 0 618 385 B1 and in U.S. patent application Ser. No. 2004/0047684 (Kusel).

However, these arrangements produce several drawbacks.

### OBJECTS OF THE INVENTION

The main goal of this invention is to reduce substantially vibration levels at handlebars of recreational vehicles at all speed and thus reduce hands, arms and shoulders fatigue of the driver by having a rubber-made absorber linking the handlebars and steering post. The invention also has to resist to high-stresses resulting from frequent use in extreme conditions. Furthermore, it has to be small, light and preserving good driving accuracy.

It is another object to provide a link having an internal system providing vertical absorption of impacts.

It is another object to provide a link having good vibration attenuation over a wide range of temperatures and vibration frequencies.

It is yet another object to provide a link comprising self-secured blocking means preventing the two plates from separation.

It is still another object to provide a link comprising internal means providing progressive stiffening in lateral torsion.

It is still another object to provide a link comprising internal means providing progressive stiffening in vertical compression.

These and other aspects and advantages of the present invention are described in the following detailed description.

### SUMMARY OF THE INVENTION

In response to the foregoing challenges, applicants have a vibration dampening connection mechanism for securing at least two components together. The vibration and noise dampening connection mechanism in accordance with the present invention includes a rubber element entrapped and bonded between two plates, linking the handlebar and the steering post of recreational vehicles. [NOTE: As used herein, the term “rubber” relates to any elastic and primarily non-metallic materials such as rubber, elastomers, or combinations thereof].

### BRIEF DESCRIPTION OF THE DRAWINGS

FIG. 1 is a plan view of an embodiment of the invention.

FIG. 2 is a cross-sectional view taken from line B-B in FIG. 1.

FIG. 3 is a cross-sectional view taken from line A-A in FIG. 1.

FIG. 4 is a plan view of an embodiment of the top plate.

FIG. 5 is a side view of an embodiment of the top plate.

FIG. 6 is a cross-sectional view taken from line C-C in FIG. 4.

FIG. 7 is a plan view of an embodiment of the bottom plate.

FIG. 8 is a cross-sectional view taken from line E-E in FIG. 7.

FIG. 9 is a cross-sectional view taken from line D-D in FIG. 7.

### DETAILED DESCRIPTION OF A PREFERRED EMBODIMENT

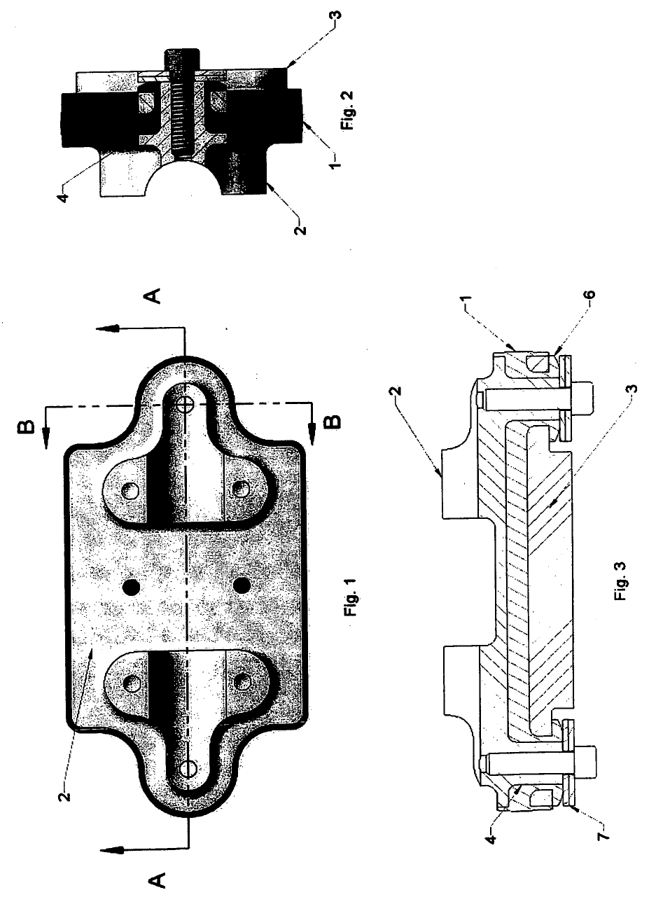

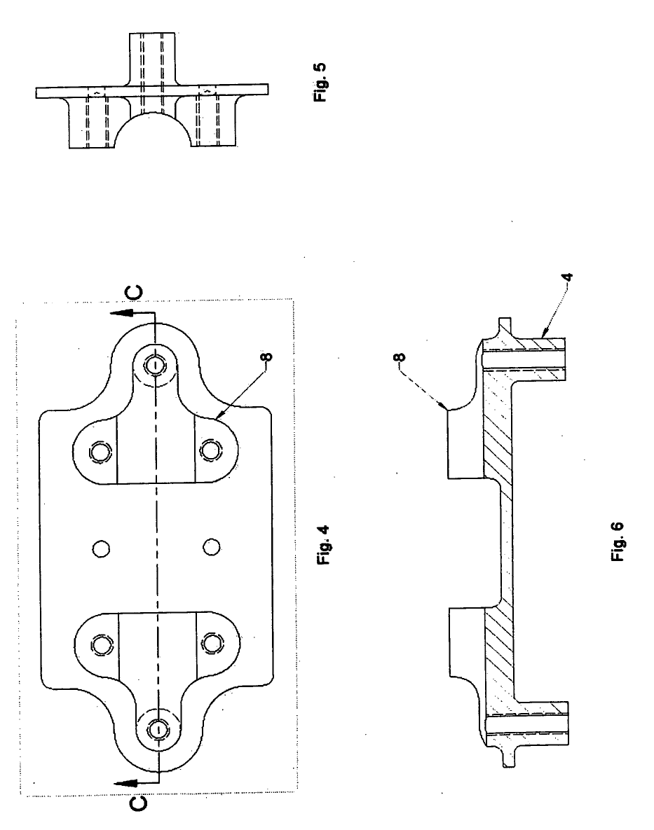

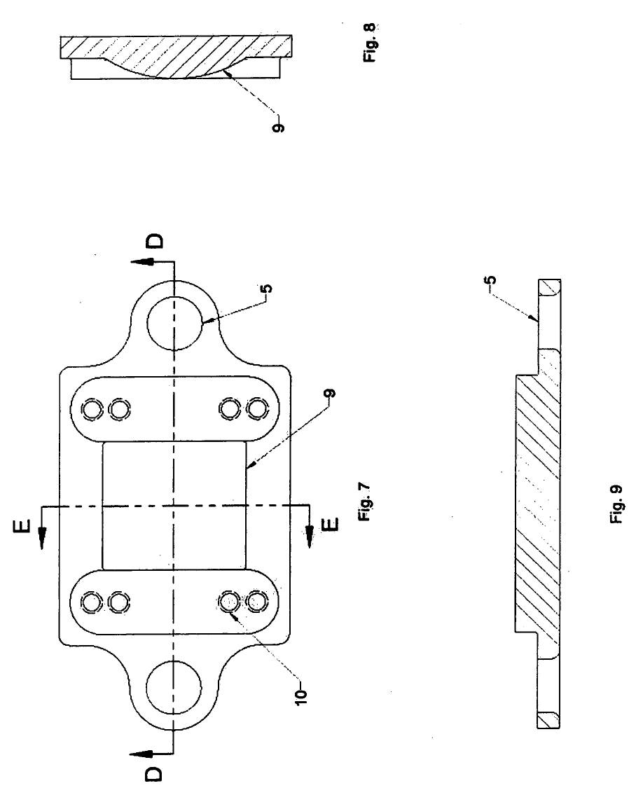

As shown in FIGS. 2 and 3, the absorber is fixed on the steering post from the bottom plate (3) and the handlebar is fixed on the top plate (2) of the absorber, preventing metal-to-metal contact between the handlebar and the steering post. The absorber comprises a rubber layer (1) entrapped and bonded between two plates (2-3). Bonding ensures integrity of the absorber. Each side of the top plate has one extruded part or more (4). Each side of the bottom plate has one hole or more (5). Each extruded part (4) goes through its associated hole (5). The top (FIGS. 4-5-6) and bottom plates (FIGS. 7-8-9) are linked together by a rubber-bonded material (1). The sectional size of the extruded parts (4) is smaller than the sectional size of the holes (5) and the gaps between the two plates are filled with rubber. This extrusion-part/hole association provides the assembly with torsion rigidity, one which gradually increases with torsion angle.

As shown in FIG. 3, each extruded part (4) sticks out of his associated hole (5). Mushroom-like rubber material (6) links the end of each extruded part (4) to the bottom plate (3). Washers or rivets (7) are fixed at the end of each extruded part (4). The washers or rivets (7) are larger than the holes (5), thus preventing the two plates (2-3) from separating. The mushroom-like rubber prevents the washers or rivets (7) from directly touching the bottom plate (3). The round shape of the mushroom-like rubber provides the assembly with progressive vertical stoppers by gradually increasing contact surface between rubber and washers or rivets (7) during vertical movement.

As shown in FIGS. 4-5-6, the top plate (2) includes an attachment piece (8) providing easy assembly of the handlebar. This piece (8) also provides extra strength of the top plate (2) by eliminating sharp edges and thus minimizing concentration of constraints. Finally, the piece (8) expands away laterally to provide more stability in the roll axis.

As shown in FIGS. 7-8-9, the bottom plate (3) includes a protuberant part (9) which ensures extra strength of the assembly in lateral and front-aft torsion. This part (9) secures the absorber's integrity when assembled on low gage metal sheets used in the production of steering posts. The bottom plate also has multiple sets of taped holes (10) to provide the absorber with adjustable positioning on the steering post.

The absorber is fixed on the steering post from the bottom plate (3) and the handlebar is fixed on the top plate (2) of the absorber. This prevents metal-to-metal contact between handlebar and steering post, thus attenuating vibration propagation from the steering column to the handlebar.

The choice of rubber-like material ensures compression and torsion stiffness while providing good vibration attenuation over a wide range of temperatures.

Although a preferred embodiment of the invention has been described in detail herein and illustrated in the accompanying figure, it is to be understood that the invention is not limited to this precise embodiment and that various changes and modifications may be effected without departing from the scope or spirit of the present invention.

1. A vibration reducing link for linking the handlebar or other similar device and the steering post of a recreational vehicle comprising a rubber-like absorber entrapped and bonded between two rigid plates.

2. A vibration reducing link according to claim 1, wherein said rubber-like material has good vibration attenuation over a wide range of temperatures and vibration frequencies.

3. A vibration reducing link according to claim 1, comprising self-secured blocking means preventing the two plates from separation.

4. A vibration reducing link according to claim 1, comprising internal means providing progressive stiffening in lateral torsion.

5. A vibration reducing link according to claim 1, comprising internal means providing progressive stiffening in vertical compression.

6. A vibration reducing link according to claim 1, comprising means to adjust the position of said link.

7. A vibration reducing link according to claim 6, wherein said means to adjust the position comprise sets of fixing holes.

8. A vibration reducing link according to claim 1, wherein the vehicle is a snowmobile, an ATV or a personal watercraft.
